(19) United States
(12) Patent Application Publication
(10) Pub. No.: US 2011/0040771 A1
(43) Pub. Date: Feb. 17, 2011

(54) DISTRIBUTED HARDWARE-BASED DATA QUERYING

(75) Inventors: Camuel Gilyadov, Petach Tikva (IL); Alexander Lazovsky, Petach Tikva (IL)

Correspondence Address: D. Kligler I.P. Services LTD, P.O. Box 25, Zippori, 17910, IL

(73) Assignee: PETASCAN LTD., Herzliya (IL)

(21) Appl. No.: 12/989,652

(22) PCT Filed: Jun. 4, 2009
(86) PCT No.: PCT/IB09/52356

§ 371 Date: Oct. 26, 2010

Related U.S. Application Data
(60) Provisional application No. 61/073,528, filed on Jun. 18, 2008.
(60) Provisional application No. 61/165,873, filed on Apr. 1, 2009.

(51) Int. Cl. G06F 17/30

(52) U.S. Cl. 707/754; 707/E17.059

(57) ABSTRACT

A data storage apparatus (20, 92, 116) includes a data processing unit (24) and multiple storage units (36, 60). Each storage unit includes one or more memory devices (40, 64), which are operative to store a data partition that is drawn from a data structure and assigned to the storage unit, and logic circuitry (44, 68, 72), which is configured to accept one or more sub-queries addressed to the storage unit and to process the respective data partition stored in the storage unit responsively to the sub-queries, so as to produce filtered data. The data processing unit is configured to transform an input query defined over the data structure into the sub-queries, to provide the sub-queries to the storage units, and to process the filtered data produced by the storage units, so as to generate and output a result in response to the input query.

### CROSS-REFERENCE TO RELATED APPLICATIONS

This application claims the benefit of U.S. Provisional Patent Application 61/073,528, filed Jun. 18, 2008, and U.S. Provisional Patent Application 61/165,873, filed Apr. 1, 2009, whose disclosures are incorporated herein by reference.

### FIELD OF THE INVENTION

The present invention relates generally to data storage and retrieval, and particularly to methods and systems for efficient processing of data queries.

### BACKGROUND OF THE INVENTION

Various methods and systems for efficient data storage and retrieval are known in the art. For example, U.S. Pat. Nos. 5,794,229 and 5,918,225, whose disclosures are incorporated herein by reference, describe database systems and methods for performing database queries. The disclosed systems implement methods for storing data vertically (i.e., by column) instead of horizontally (i.e., by row). Each column comprises a plurality of cells, which are arranged on a data page in a contiguous fashion. By storing data in a column-wise basis, a query can be processed by bringing in only data columns that are of interest, instead of retrieving row-based data pages consisting of information that is largely not of interest to the query.

U.S. Patent Application Publication 2004/0139214, whose disclosure is incorporated herein by reference, describes a pipeline processor for a data engine that can be programmed to recognize record and field structures of received data. The pipeline processor receives a field-delineated data stream and employs logical arithmetic methods to compare fields with one another, or with values otherwise supplied by general purpose processors, to determine which records are worth transferring to memory.

U.S. Patent Application Publications 2004/0148420 and 2004/0205110, whose disclosures are incorporated herein by reference, describe an asymmetric data processing system having two or more groups of processors having attributes that are optimized for their assigned functions. A first processor group is responsible for interfacing with applications and/or end users to obtain queries, and for planning query execution. A second processor group consists of streaming record-oriented processors, which carry out the bulk of the data processing required to implement the logic of a query.

U.S. Pat. Nos. 7,315,849, whose disclosure is incorporated herein by reference, describes an enterprise-wide data-warehouse comprising a database management system (DBMS), which includes a relational data-store storing data in tables. An aggregation module aggregates the data stored in the tables of the relational data-store and stores the aggregated data in a non-relational data-store. A reference generating mechanism generates a first reference to data stored in the relational data-store, and a second reference to aggregated data generated by the aggregation module and stored in the non-relational data-store. A query processing mechanism processes query statements, wherein, upon identifying that a given query statement is on the second reference, the query processing mechanism communicates with the aggregation module to retrieve portions of aggregated data identified by the reference that are relevant to the given query statement.

In some known schemes, data is stored in Flash memory devices. For example, U.S. Patent Application Publication 2008/0040531, whose disclosure is incorporated herein by reference, describes a data storage device comprising at least two Flash devices and a controller that are integrated on a circuit board. The device further includes at least one NOR Flash device in communication with the controller through a host bus, and at least one host bus memory device in communication with the controller and the NOR Flash device through the host bus. At least one interface is in communication with the controller, and is adapted to physically and electrically couple to a system, receive and store data from the system, and retrieve and transmit data to the system.

U.S. Patent Application Publication 2008/0052451, whose disclosure is incorporated herein by reference, describes a Flash storage chip in which a microcontroller, a Flash memory and a Peripheral Component Interconnect Express (PCI Express) connecting interface are integrated on a single circuit board.

### SUMMARY OF THE INVENTION

An embodiment of the present invention provides a data storage apparatus, including:

multiple storage units, each storage unit including:
one or more memory devices, which are operative to store a data partition that is drawn from a data structure and assigned to the storage unit; and
logic circuitry, which is configured to accept one or more sub-queries addressed to the storage unit and to process the respective data partition stored in the storage unit responsively to the sub-queries, so as to produce filtered data; and

a data processing unit, which is configured to transform an input query defined over the data structure into the sub-queries, to provide the sub-queries to the storage units, and to process the filtered data produced by the storage units, so as to generate and output a result in response to the input query.

In some embodiments, the data structure includes data elements stored in multiple rows and columns, and the data processing unit is configured to divide the data structure into multiple tiles, each tile including the data elements that are stored in an intersection of a respective first sub-range of the rows and a respective second sub-range of the columns, and to store the data structure by distributing the tiles among the storage units. In an embodiment, the data processing unit is configured to distribute the tiles among the memory devices in accordance with a random pattern.

In another embodiment, the data processing unit is configured to distribute a subset of the tiles that are associated with a given sub-range of the rows substantially evenly among the memory devices. In yet another embodiment, the data processing unit is configured to distribute a first subset of the tiles that are associated with a first sub-range of the rows among the memory devices according to a first distribution, and to distribute a second subset of the tiles that are associated with a second sub-range of the rows, which succeeds the first sub-range, according to a second distribution that is different from the first distribution.

In still another embodiment, the logic circuitry in a given storage unit is configured to store a given tile in the memory devices in a first orientation, and, in response to a given sub-query that addresses the given tile, to rotate the given tile to a second orientation and to execute the given sub-query using the rotated tile. In a disclosed embodiment, the data processing unit is configured to define a given sub-query that addresses a given data partition stored in a given storage unit, and to provide the given sub-query to the given storage unit for processing. In an embodiment, the logic circuitry in a given storage unit is configured to filter the data partition stored in the given storage unit responsively to one or more of the sub-queries addressed to the storage unit.

In some embodiments, the data processing unit is configured to apply additional filtering to the filtered data produced by the storage units. In a disclosed embodiment, the logic circuitry in a given storage unit is configured to perform a data aggregation operation on the data partition stored in the given storage unit responsively to one or more of the sub-queries addressed to the storage unit. In another embodiment, the logic circuitry in a given storage unit is configured to apply at least one of a logic operation and an arithmetic operation to the data partition stored in the given storage unit. In yet another embodiment, the logic circuitry includes programmable logic, and the data processing unit is configured to reconfigure the programmable logic responsively to a criterion defined over at least one of the data structure and the input query. In still another embodiment, a given storage unit includes at least one asymmetric interface for data storage and retrieval in the memory devices of the given storage unit, the asymmetric interface having a first bandwidth for the data storage and a second bandwidth, higher than the first bandwidth, for the data retrieval.

In some embodiments, the logic circuitry in a given storage unit is configured to compress at least some of the data partition assigned to the given storage unit prior to storing the data partition in the memory devices. The logic circuitry in the given storage unit may be configured to apply a given sub-query to the compressed data partition so as to produce the filtered data, and to decompress only the filtered data. In an embodiment, the data processing unit is configured to encrypt data exchanged with the storage units and with end users. In another embodiment, the logic circuitry in a given storage unit is configured to encrypt data stored in the memory devices.

In some embodiments, the apparatus includes multiple Network Interface Cards (NICs) coupled to the respective storage units, and the storage units are configured to exchange data over a network via the respective NICs. In an embodiment, the storage units are configured to communicate with one another so as to exchange data for processing the sub-queries. In another embodiment, the data processing unit is configured to identify input queries whose processing accesses common data elements, and to cause the storage units to access the common data elements jointly while processing the identified input queries. In yet another embodiment, the data processing unit is configured to convert the data structure into a raw data format, so as to produce data partitions having the raw data format for storage in the storage units.

In an embodiment, the data processing unit is configured to represent a given data partition, which is assigned to a given storage unit and has a given data format, using code that is executable by the given storage unit, and the logic circuitry in the given storage unit is configured to access the given data format by executing the code. In another embodiment, the logic circuitry in a given storage unit is configured to communicate using a communication protocol that is compatible with another type of storage units, which do not have query processing capabilities.

In yet another embodiment, the data processing unit is configured to allocate first and second separate sets of hardware elements in the multiple storage units to respective first and second user groups, and to prevent access of users in the first group to the hardware elements in the second set. The allocated hardware elements may include at least one element type selected from a group of types consisting of ones of the storage units, ones of the memory devices and parts of the logic circuitry. In some embodiments, the data processing unit is configured to measure an amount of a resource of the apparatus that is used in processing the input query. In an embodiment, the logic circuitry in a given storage unit is configured to deactivate at least one hardware component of the given storage unit so as to reduce power consumption of the given storage unit. In a disclosed embodiment, the logic circuitry in a given storage unit is configured to run one of a Structured Query Language (SQL) query processor and a SQL rule engine.

There is additionally provided, in accordance with an embodiment of the present invention, a data storage apparatus, including:

a storage unit, which includes:
one or more memory devices, which are operative to store data; and
circuitry, which is configured to apply a first filtering operation to the stored data in response to a query defined over the data, so as to produce pre-filtered data; and

a data processing unit, which is configured to receive the pre-filtered data from the storage unit and to apply a second filtering operation to the pre-filtered data, so as to produce a result of the query.

There is also provided, in accordance with an embodiment of the present invention, a data storage apparatus, including:

a storage unit, which includes:
one or more memory devices, which are operative to store data; and
circuitry, which is configured to apply a data aggregation operation to the stored data in response to a query defined over the data, so as to produce pre-processed data; and

a data processing unit, which is configured to receive the pre-processed data from the storage unit and to process the pre-processed data, so as to produce a result of the query.

In some embodiments, the data aggregation operation includes computation of a statistical property of at least some of the stored data. Additionally or alternatively, the data aggregation operation includes computation of a sum of at least some of the stored data. Further additionally or alternatively, the data aggregation operation includes producing a sample of at least some of the stored data.

There is further provided, in accordance with an embodiment of the present invention, a method for data storage, including:

storing a plurality of data partitions drawn from a data structure in a respective plurality of storage units;

transforming an input query defined over the data structure into multiple sub-queries and providing the sub-queries to the storage units;

using logic circuitry in each storage unit, accepting one or more of the sub-queries addressed to the storage unit, and processing a respective data partition stored in the storage unit responsively to the accepted sub-queries, so as to produce filtered data; and

processing the filtered data produced by the multiple storage units, so as to generate and output a result in response to the input query.

There is additionally provided, in accordance with an embodiment of the present invention, a method for data storage, including:

storing data in a storage unit that includes processing circuitry;

using the processing circuitry in the storage unit, applying a first filtering operation to the stored data in response to a query defined over the data, so as to produce pre-filtered data; and

applying a second filtering operation to the pre-filtered data by a processor separate from the storage unit, so as to produce a result of the query.

There is also provided, in accordance with an embodiment of the present invention, a method for data storage, including:

storing data in a storage unit that includes processing circuitry;

using the processing circuitry in the storage unit, applying a data aggregation operation to the stored data in response to a query defined over the data, so as to produce pre-processed data; and

processing the pre-processed data by a processor separate from the storage unit, so as to produce a result of the query.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for data storage and retrieval, in accordance with an embodiment of the present invention;

FIG. 2 is a diagram that schematically illustrates partitioning of tabular data into tiles, in accordance with an embodiment of the present invention;

FIG. 3 is a block diagram that schematically illustrates a queriable data storage unit, in accordance with an embodiment of the present invention;

FIG. 4 is a block diagram that schematically illustrates filtering logic in a queriable data storage unit, in accordance with an embodiment of the present invention;

FIGS. 5 and 6 are block diagrams that schematically illustrate systems for data storage and retrieval, in accordance with alternative embodiments of the present invention;

FIG. 7 is a flow chart that schematically illustrates a method for data storage, in accordance with an embodiment of the present invention;

FIG. 8 is a flow chart that schematically illustrates a method for query processing, in accordance with an embodiment of the present invention;

FIG. 9 is a diagram that schematically illustrates a data rotation process, in accordance with an embodiment of the present invention;

FIG. 10 is a block diagram that schematically illustrates a system for data storage and retrieval, in accordance with another embodiment of the present invention; and

FIGS. 11-17 are block diagrams that schematically illustrate example interconnection topologies in a queriable data storage unit, in accordance with embodiments of the present invention.

### DETAILED DESCRIPTION OF EMBODIMENTS

### Overview

Embodiments of the present invention that are described herein provide improved methods and systems for data storage and for data retrieval in response to queries. In some embodiments, a storage system comprises a data processing unit, which stores data in multiple storage units. In addition to memory devices that hold the data, each storage unit comprises filtering logic, which is capable of applying query processing operations to the data stored in the unit. The storage units described herein are therefore referred to as “queriable storage units.”

In a typical flow, the data processing unit receives a query that is defined over the stored data. The data processing unit translates the query into a set of sub-queries, which are to be executed concurrently by the storage units. Each storage unit applies the sub-queries that are addressed to it, thereby pre-filtering its locally-stored data. The pre-filtered data produced by the different storage units is collected and processed by the data processing unit, so as to generate a result of the original query.

The above-described configuration is particularly effective in processing analytical queries, i.e., queries that scan a large number of data items rather than targeting a specific data item. Since the stored data is pre-filtered locally by the storage units, the volume of data transferred to the data processing unit is reduced considerably. In addition, the processing load on the data processing unit is considerably reduced, since most (and sometimes all) irrelevant data is discarded by the storage units and does not reach the data processing unit. Moreover, since the query processing task is partitioned and carried out in parallel by multiple storage units, query response time is reduced considerably.

In some embodiments, the data processing unit partitions the data for storage among the different storage units in a way that maximizes the concurrent processing of analytical queries. In an example embodiment, the data processing unit divides a body of tabular data (e.g., a database table) into two-dimensional tiles, and distributes the tiles at random among the different memory devices of the different storage units. Since an analytical query typically involves scanning a selected set of data columns over the entire data body, this sort of partitioning distributes the query processing load approximately evenly over the filtering logic of the different storage units. As a result, parallelization of the query processing task is maximized.

Several example system configurations, as well as several example configurations of queriable storage units, are described herein. Additional aspects, such as compression and encryption, multitenant operation, and compatibility with legacy systems that use non-queriable storage units, are also addressed.

### System Description

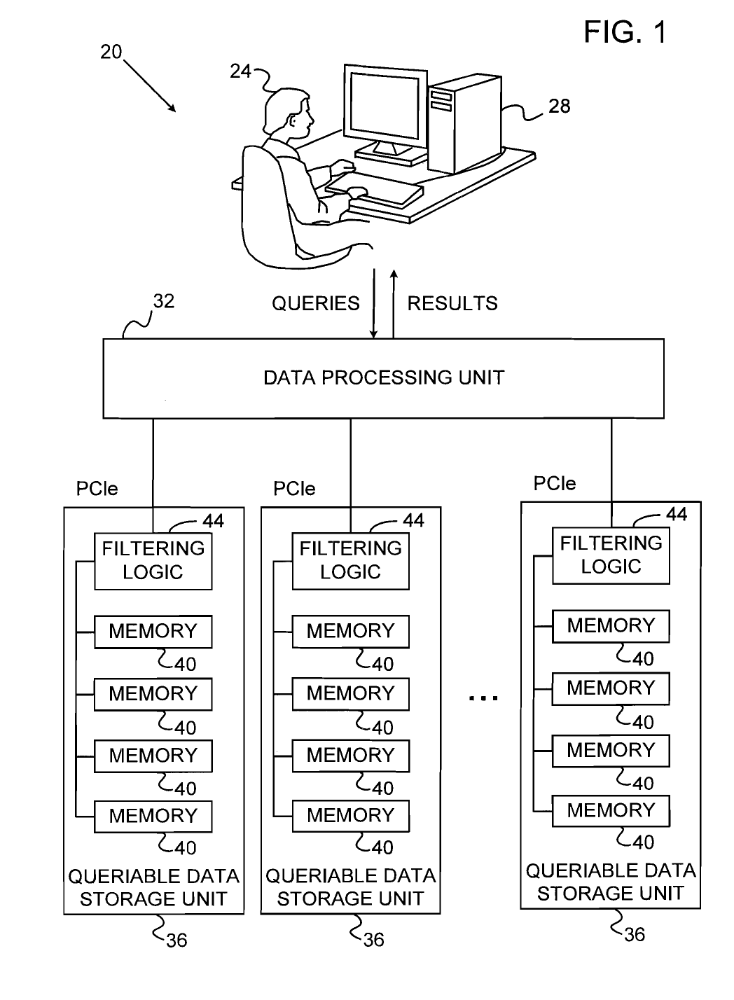

FIG. 1 is a block diagram that schematically illustrates a system 20 for data storage and retrieval, in accordance with an embodiment of the present invention. System 20 stores and processes a body of data, such as multiple records of a database. Typically although not necessarily, the data has a tabular structure, i.e., comprises data elements that are arranged in multiple rows and columns. System 20 receives queries related to the stored data, queries the data using methods that are described hereinbelow, and produces query results. In the example of FIG. 1, system 20 receives the queries from a user 24 via a user terminal 28, and presents the query results using the user terminal. Alternatively, however, system 20 can exchange data, queries and results with any other computerized system, e.g., over a network. Although FIG. 1 shows only a single user, in a typical application system 20 serves multiple users. The users may be connected to unit 32 using a direct connection, over a network such as the Internet, or using any other suitable interconnection means.

As will be explained in detail below, system 20 stores and processes the data in a distributed manner that is particularly suitable for processing analytical queries. Processing of analytical queries typically involves scanning and analyzing a large number of data items (often the entire body of data), rather than targeting a specific record or data item. An analytical query may specify a certain logical condition, and request retrieval of the data records that meet this condition. Another kind of analytical query may request that a certain calculation be applied to a large number of data records.

For example, in a database that stores records of sales transactions, analytical queries may be used for retrieving all transactions whose sales price was higher than a certain value, retrieving all transactions in which the profit was higher than a certain value, or calculating the average delivery time of a certain product. Analytical queries are commonly used in a wide variety of applications, such as data mining, business intelligence, telecom fraud detection, click-fraud prevention, Web-commerce, financial applications, homeland security and law enforcement investigations, Web traffic analysis, money laundering prevention applications and decision support systems. Although the configuration of system 20 is optimized for processing analytical queries, it is suitable for processing other types of queries, such as transactional queries, as well.

System 20 comprises a central data processing unit 32, which is connected to multiple storage units 36. The number of storage units per system may vary considerably, but is usually in the range of several tens to several hundred units. Generally, however, the system may comprise any desired number of storage units. In the present example, storage units 36 are connected to data processing unit 32 using a Peripheral Component Interconnect Express (PCIe) interface. Alternatively, however, any other suitable interface can also be used.

Storage units 36 are referred to herein as “queriable storage units,” since they perform query processing (e.g., filtering or data aggregation) functions on the data stored therein. Each storage unit 36 comprises one or more memory devices 40, which store selected portions of the data body, and filtering logic 44, which performs filtering and other query processing functions on the data stored in memory devices 40 of the data storage unit.

In a typical flow, data processing unit 32 receives an analytical query from user 24, and translates this query into a set of lower-level sub-queries to be performed by queriable data storage units 36. The sub-queries are carried out in parallel by the storage units. Each storage unit 36 performs the sub-queries pertaining to its locally-stored data, so as to produce filtered data. Each unit 36 sends its filtered data, i.e., the results of its sub-queries, back to data processing unit 32. Unit 32 combines the filtered data produced by units 36, and may apply additional filtering. Unit 32 thus produces a query result, which is provided to user 24 in response to the analytical query.

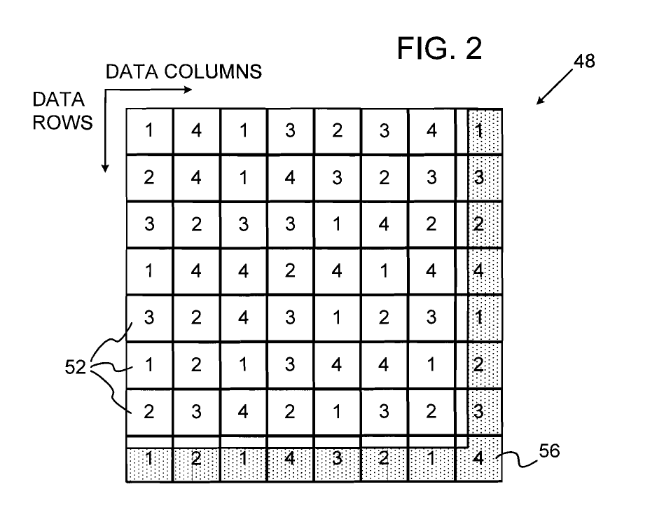

The configuration of system 20 is highly effective in processing analytical queries for several reasons. Since the stored data is pre-filtered locally by storage units 36, the volume of data transferred from storage units 36 to data processing unit 32 is reduced considerably. As a result, relatively low-cost interfaces such as PCIe can be used, even for large databases. In addition, the processing load on unit 32 is considerably reduced, since most (and sometimes all) irrelevant data is discarded by storage units 36 and does not reach unit 32. Moreover, since the query processing task is partitioned and carried out in parallel by multiple storage units 36, query response time is reduced considerably. FIG. 2 below illustrates a storage scheme, which partitions the data among the storage units and memory devices in a way that maximizes processing concurrency.

Memory devices 40 in units 36 may comprise any suitable type of memory. In some embodiments, some or all of devices 40 comprise non-volatile memory devices such as Flash memory devices. Additionally or alternatively, some or all of devices 40 may comprise volatile memory devices, typically Random Access Memory (RAM) devices such as Dynamic RAM (DRAM) or Static RAM (SRAM). Other examples of memory devices that can be used to implement devices 40 may comprise Ferroelectric RAM (FRAM), Magnetic RAM (MRAM) or Zero-capacitor RAM (Z-RAM). Although the embodiments described herein mainly address storage in solid-state memory devices, the methods and systems described herein can also be used for data storage in other types of storage media, such as Hard Disk Drives (HDD).

Devices 40 may comprise devices of any suitable type, such as, for example, unpackaged semiconductor dies, packaged memory devices, Multi-Chip Packages (MCPs), as well as memory assemblies such as MicroSD, TransFlash or Secure Digital High Capacity (SDHC) cards. Filtering logic 44 may comprise any suitable type of logic circuitry, such as, for example, one or more Field-Programmable Gate Arrays (FPGAs) or other kinds of programmable logic devices, Application-Specific Integrated Circuits (ASICs) or full-custom devices. Logic 44 may comprise unpackaged dies, packaged devices, boards comprising multiple devices (e.g., FPGAs, static or dynamic RAM devices and/or ancillary circuitry), and/or any other suitable configuration.

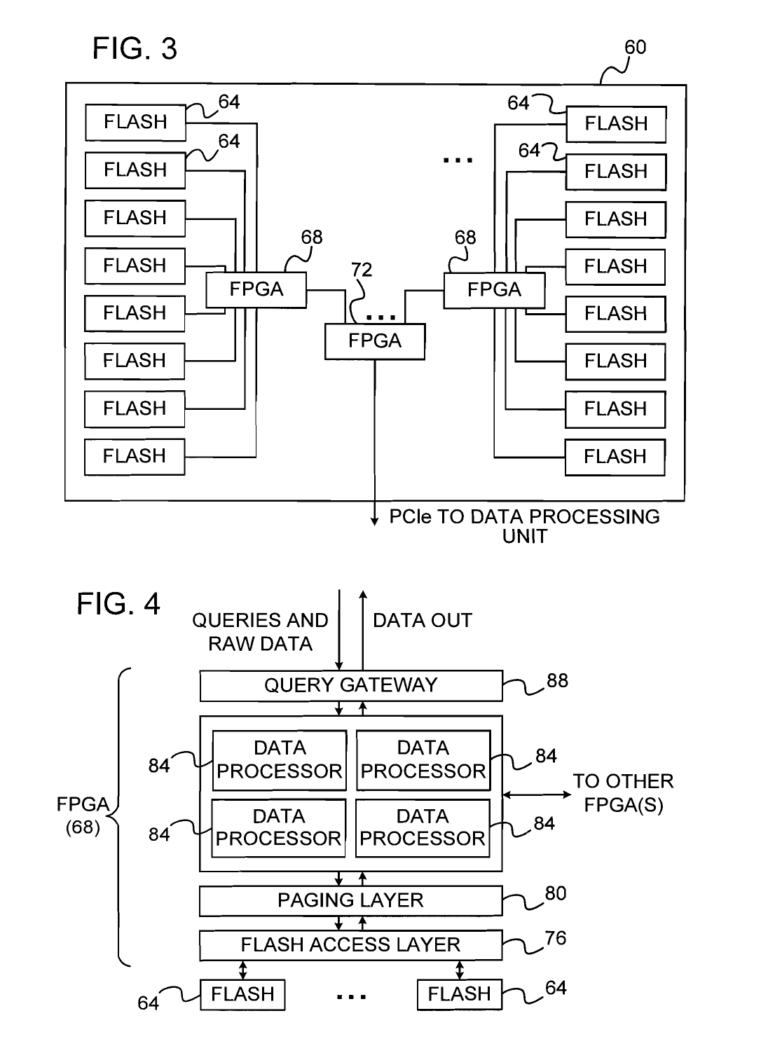

An example configuration of unit 36 may comprise several tens and up to several hundreds of memory devices 40, and up to several tens of FPGAs. Such a unit could be constructed, for example, on a 100 mm-by-300 mm, six-layer PCB. Alternatively, any other suitable configuration can also be used. Several example interconnection schemes of memory devices and filtering logic are described and explained in FIGS. 3 and 11-17 below.

In a typical implementation, units 36 use non-volatile memory devices (e.g., Flash devices) for long-term data storage. Volatile memory devices are typically used as a scratchpad memory, as a buffer for storing interim results such as query results, as a queue between FPGAs for carrying out pipelined query processing, as a cache for temporary storage of data retrieved from non-volatile memory (e.g., frequently-used data), for caching sorted or indexed data during query processing, or for any other suitable purpose. In some embodiments, unit 36 uses volatile memory as a primary storage space for new incoming data, in order to expedite the storage process (e.g., update or insert transactions). In these embodiments, redo records (redo logs), which enable rollback of these transactions, are typically stored in non-volatile memory. Additionally or alternatively, data that is stored in volatile memory may be replicated in at least one other volatile memory location, and the memories are protected against power failure (e.g., using an Uninterruptible Power Supply—UPS, batteries or capacitors). Two example configurations of queriable storage units comprising both Flash and RAM devices are shown in FIGS. 16 and 17 below.

Data processing unit 32 may comprise one or more servers, Single-Board Computers (SBCs) and/or any other type of computing platform. In some embodiments, unit 32 comprises appropriate software modules that enable it to interact with conventional Database Management Systems (DBMSs), such as Oracle® or DB2® systems. In some embodiments, system 20 is integrated as a foreign engine into a conventional DBMS (sometimes referred to in this context as an “ecosystem”), typically via a gateway. Using this technique, system 20 appears to the DBMS as a conventional storage system, even though query processing performance is improved by applying the methods and systems described herein. Typically, data processing unit 32 comprises one or more general-purpose computers, which are programmed in software to carry out the functions described herein. The software may be downloaded to the computers in electronic form, over a network, for example, or it may, alternatively or additionally, be provided and/or stored on tangible media, such as magnetic, optical, or electronic memory.

The elements of system 20 may be fabricated, packaged and interconnected in any suitable way. For example, each data storage unit 36 may be fabricated on a Printed Circuit Board (PCB). The PCBs may be connected to unit 32 using a motherboard or backplane (e.g., PCIe-based backplane), using board stacking (e.g., PCIe-based board stacking), using inter-board cabling or using any other suitable technique. The interconnection scheme may use any suitable, standard or proprietary, communication protocol. In some embodiments, units 36 can be hot-swapped, i.e., removed from or inserted into system 20 during operation.

In some embodiments, system 20 may comprise hundreds or thousands of memory devices 40. The distributed configuration of system 20 enables the memory devices to be accessed individually and in parallel, in response to analytical queries.

In some embodiments, storage units 36 may communicate with one another, either directly or via unit 32. This sort of communication is advantageous for processing certain types of queries, such as relation joining. Interconnection among units 36 can be carried out, for example, using an Infiniband network, or using any other suitable means.

### Data Partitioning for Efficient Parallel Processing

In some embodiments, data processing unit 32 partitions the data for storage among the different data storage units and memory devices in a way that maximizes the concurrent processing of analytical queries.

Consider, for example, a body of tabular data, such as a database table that stores records of sales transactions. This sort of data typically comprises multiple rows and columns. Each row represents a respective database entry, e.g., a sales transaction. Each row comprises multiple fields, such as client name, transaction date and time, sales price, profit and/or any other relevant information. In this sort of structure, each field is stored in a respective set of (one or more) columns. For example, a given set of columns may store the client names in the different transactions, and another set of columns may store the sales prices. (The examples given herein refer mainly to databases that store sales transactions. This choice, however, is made purely for the sake of conceptual clarity. The methods and systems described herein can be used with any other suitable data structure and application.)

Typically, processing an analytical query involves access to a relatively large number of rows (often all rows), but on the other hand involves access to a relatively small number of columns. For example, a query that requests retrieval of all records whose sales price is higher than a certain value involves access to all database records, but is concerned only with the columns that store the transaction sales prices.

In some embodiments, data processing unit 32 partitions the data, and assigns data partitions for storage in the different storage units 36. In some embodiments, unit 32 partitions the data down to the individual memory device level, i.e., determines which portion of the data is to be stored in each individual memory device 40 within a given unit 36. The partitioning attempts to maximize parallel processing of analytical queries by distributing the rows and columns of the tabular data approximately evenly among the memory devices or storage units.

FIG. 2 is a diagram that schematically illustrates partitioning of a data table 48, in accordance with an embodiment of the present invention. Data processing unit 32 divides the data table, which comprises multiple rows and columns, into two-dimensional blocks that are referred to herein as tiles 52. A given tile contains the data elements residing in an intersection of a certain sub-range of the rows and a certain sub-range of the columns. A typical tile size is on the order of 4-by-4 to 100-by-100 data elements, although any other suitable tile size can also be used.

Unit 32 allocates tiles 52 for storage in memory devices 40 or storage units 36 in a way that distributes the row and column content of table 48 approximately evenly among the memory devices or storage units. For example, unit 32 may assign tiles 52 to memory devices 40 according to a random pattern, a pseudo-random pattern, or a predefined distribution pattern having random or pseudo-random properties. All of these patterns are regarded herein as different kinds of random patterns.

As noted above, each tile contains the data elements residing in an intersection of a certain sub-range of the rows and a certain sub-range of the columns of table 48. As such, each tile can be identified by the group of rows and the group of columns to which its elements belong. A given query involves access to a certain set of columns, which may comprise a single column, a subset of the columns or even all columns of table 48.

In some embodiments, unit 32 assigns tiles to memory devices in a manner that distributes the processing load approximately evenly among the different memory devices, for any set of columns that may be accessed by a given query. For example, unit 32 may distribute the tiles to the memory devices according to the following two rules:
The tiles belonging to a certain row group should be distributed as evenly as possible among the memory devices.
For a given row group, the distribution among the memory devices should differ (i.e., follow a different permutation) from the distribution of the previous row group in the table. In other words, tiles belonging to the same column group but to successive row groups should be assigned to different memory devices.

When following these two rules, the utilization of the memory devices remains approximately uniform (and therefore the query processing load is well parallelized) regardless of the column group to be accessed. The distribution of tiles to memory devices may be implemented using various kinds of functions, which are not necessarily random or pseudo-random. For example, various kinds of hashing functions or placement functions can be used. Such functions may be defined, for example, on a set of five variables, namely a column group identifier, a row group identifier, a memory device identifier, a current row group identifier and a current column group identifier. Alternatively, unit 32 may assign tiles 52 to memory devices 40 according to any other suitable allocation scheme.

FIG. 2, for example, shows a distribution of tiles 52 to four memory devices. Each tile in FIG. 2 is marked with a digit in the range 1 . . . 4, which indicates the memory device in which the tile is to be stored. The example of FIG. 2 refers to four memory devices for the sake of clarify, although typically the number of memory devices or storage units is considerably higher. In a typical application, a large database table may be divided into thousands or even millions of tiles.

The description herein refers to a single table for the sake of clarity. In practice, however, the data may comprise multiple tables. In such cases, unit 32 divides each table into tiles and assigns the tiles to memory devices 40. When assigning tiles 52 to memory devices 40, a given memory device may store a single tile or multiple tiles. Generally, a given memory device 40 may store tiles that belong to different tables. In some cases, table 48 has a size that cannot be divided into an integer number of tiles. In such cases, unit 32 may extend the number of rows and/or columns of the table, e.g., by adding dummy data, in order to reach an integer number of tiles. This operation is commonly known as data padding, and an example of such padding is shown by a region 56 in table 48.

When using the partitioning and tile assignment schemes described herein, each storage unit 36 stores a group of tiles, which are drawn from a diverse mix of row and column ranges. As a result, processing of an analytical query will typically involve access to data that is distributed approximately evenly among the storage units and memory devices. The sub-query processing (e.g., filtering) tasks will therefore distribute approximately evenly among the different storage units. In other words, processing of the analytical query is parallelized efficiently among the queriable storage units, thus minimizing response time and balancing the communication load across the different interfaces.

### Queriable Data Storage Unit Configuration

FIG. 3 is a block diagram that schematically illustrates a queriable data storage unit 60, in accordance with an embodiment of the present invention. The configuration of unit 60 can be used to implement units 36 in system 20 of FIG. 1. The filtering logic in unit 60 comprises a number of FPGAs 68, and additional control circuitry, e.g., an FPGA 72. Each FPGA 68 controls a respective set of Flash memory devices 64. FPGA 72 communicates with FPGAs 68 and manages the PCIe interface between storage unit 60 and data processing unit 32. The interfaces in unit 60 that are used for communicating with the memory devices (e.g., the interfaces between FPGA 72 and FPGAs 68) are often highly asymmetric, since analytical queries typically involve a relatively high number of read operations and a relatively low number of write operations. In a typical configuration, unit 60 comprises eight FPGAs 68, each controlling eight Flash devices 64, so that the total number of Flash memory devices per unit 60 is sixty-four. Alternatively, any other suitable number of FPGAs 68, and/or Flash devices 64 per FPGA 68, can also be used.

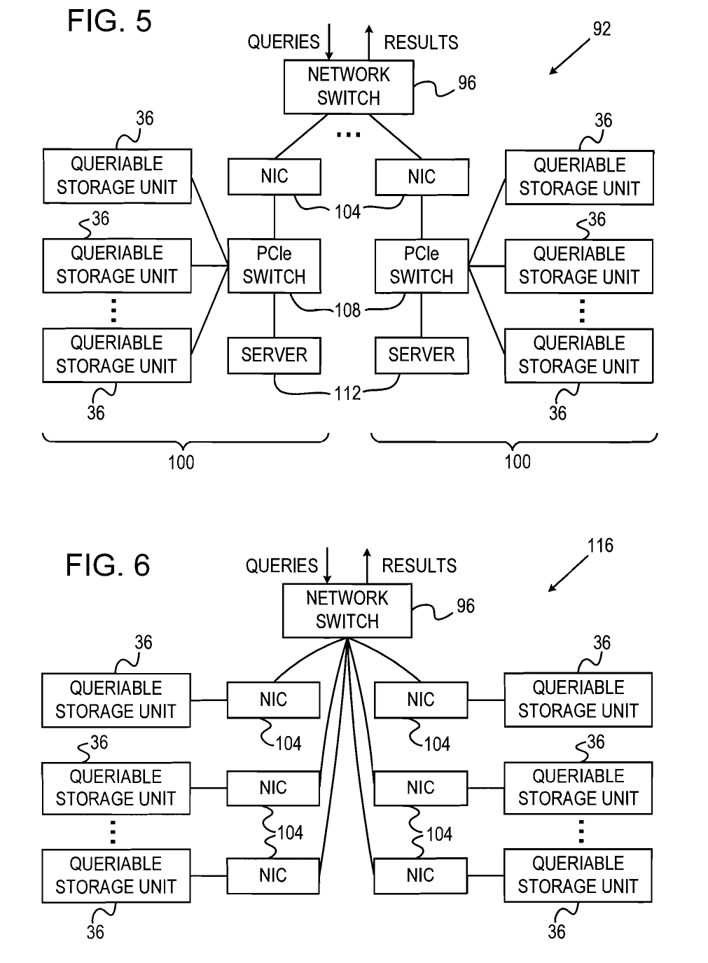

FIG. 4 is a block diagram that schematically illustrates the internal structure of FPGA 68 in queriable data storage unit 60, in accordance with an embodiment of the present invention. FPGA 68 in the present example comprises a Flash access layer 76, which functions as a physical interface to the Flash memory devices 64 that are associated with this FPGA. A paging layer 80 performs page-level storage and caching to Flash memory devices 64. Layer 80 forwards requested pages retrieved from devices 64 to upper layers.

FPGA 68 further comprises multiple data processors 84 operating in parallel, which carry out the data pre-filtering functions of the FPGA. The data processors operate on pages or record sets that are retrieved from devices 64 and provided by layer 80. Computation results are forwarded to upper layers of the FPGA. Each data processor 84 typically comprises a programmable pipelined processor core, which is capable of performing logic operations (e.g., AND, OR or XOR), arithmetic operations (e.g., addition, subtraction, comparison to a threshold, or finding of minimum or maximum values), or any other suitable type of operations. In some embodiments, processors 84 can communicate with one another, so as to obtain pages or record sets from other processors or to provide computation results to other processors. Processors 84 may also communicate with processors in other FPGAs 68 or in other units 60, so as to exchange data and/or computation results.

In some embodiments, the configuration of FPGA 68 is fixed and does not change during operation. In alternative embodiments, FPGA 68 can be reconfigured by unit 32, for example in order to match a certain query type, to match a certain data type, per each specific table, for supporting custom problem-domain functions by processors 84, or according to any other suitable criterion.

Generally, the FPGA can be configured so as to interpret and process the specific structure of the data in question, or the specific type of query in question. In many cases, FPGA resources (e.g., die space or gate count) are limited and cannot support dedicated interpretation and processing of multiple different types of data or queries. Therefore, the FPGA may be reconfigured to match a given task or data type. A given FPGA can be reconfigured, for example, in order to perform operations such as integer arithmetic, floating-point arithmetic, vector arithmetic, Geographic Information System (GIS) support, text search and regular expression filtering, full-text index-based filtering, binary tree index based filtering, bitmap index based filtering, or voice and video based filtering.

A query gateway layer 88 compiles incoming sub-queries for processing by processors 84, and distributes the sub-queries to processors 84. In the opposite direction, layer 88 packages the sub-query results (filtered data), and forwards the results to FPGA 72 or directly to unit 32. The filtered data can be packaged using any suitable format, such as using Extensible Markup Language (XML) or JavaScript Object Notation (JSON).

The configuration of FPGA 68 shown in FIG. 4 is an example configuration, which is shown purely for the sake of conceptual clarity. In alternative embodiments, filtering logic having any other suitable configuration can also be used.

In some embodiments, FPGA 68 compresses the data before it is stored in Flash devices 64, in order to achieve higher storage capacity. When data is read from Flash devices 64, the data is decompressed before it is provided to processors 84 for further processing. Compression and decompression are typically carried out by paging layer 80. Any suitable compression and decompression scheme, such as run-length schemes, bitmap schemes, differential schemes or dictionary-based schemes, can be used for this purpose.

In many practical cases, however, most of the data that is decompressed during query processing is irrelevant to the query. Decompression of all data is often extremely computationally-intensive, and may sometimes outweigh the benefit of compression in the first place. This effect is especially significant, for example, in highly-analytical applications that continually retrieve historic data.

In order to prevent unnecessary decompression of irrelevant data, in some embodiments FPGA 68 filters the data in its compressed form, and then decompresses the filtering results. Consider, for example, a dictionary-based compression scheme in which a certain column holds values in the range 1000001 . . . 1000009. The column can be compressed by omitting the 1000000 base value, and storing only values in the range 1 . . . 9 in the memory devices. Consider an example query, which requests retrieval of the values 1000005 and 1000007 from this column.

If the column were to be decompressed before filtering, a large number of irrelevant data (all the data elements whose values are different from 1000005 and 1000007) would be decompressed (converted from 1 . . . 9 values to 1000001 . . . 1000009 values). In order to prevent this unnecessary processing, unit 32 modifies the original query to search for the compressed values in the compressed column, i.e., to search for the values 5 and 7 in the 1 . . . 9 value range. Then, decompression is applied only to the filtering results, i.e., the retrieved 5 and 7 values are converted to 1000005 and 1000007 values. As can be appreciated, decompressing the filtered results reduced the amount of processing considerably.

In some embodiments, the stored data, as well as data exchanged between different system elements, is encrypted. In an example application, encryption is applied to (1) data exchanged between different FPGAs, such as between FPGA 68 and FPGA 72, (2) data exchanged between storage unit 36 and external elements, such as data processing unit 32 or with end users, and (3) data stored in Flash devices 64. Encryption/decryption of the stored data is typically performed by paging layer 80. Encryption/decryption of data exchanged between FPGAs, and of data exchanged between unit 36 and external elements, may be performed by query gateway 88 and/or by processors 84. Any suitable encryption scheme, such as Public Key Infrastructure (PKI), can be used for this purpose.

### Alternative System Configurations

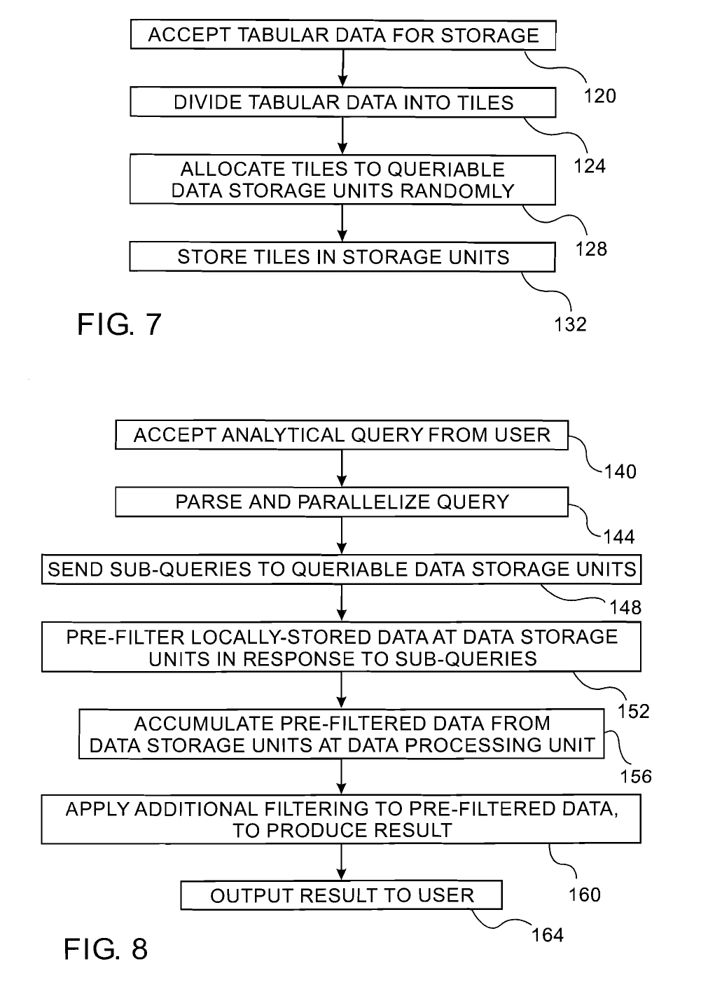

FIG. 5 is a block diagram that schematically illustrates a system 92 for data storage and retrieval, in accordance with an alternative embodiment of the present invention. System 92 operates in a similar manner to system 20 of FIG. 1, using a clustered, network-based structure. System 92 comprises one or more storage sub-systems 100, which receive queries and provide results via a network switch 96. Each sub-system 100 comprises a Network Interface Card (NIC) 104 for communicating with switch 96, a PCIe switch 108 for communicating with a set of queriable storage units 36, and a server 112 that carries out functions similar to data processing unit 32. The configuration of FIG. 5 uses a cluster of multiple servers, which enables scalability in processing power and storage capacity.

FIG. 6 is a block diagram that schematically illustrates a system 116 for data storage and retrieval, in accordance with yet another embodiment of the present invention. System 116 operates similarly to systems 20 and 92. In system 116, however, each queriable storage unit 36 communicates individually with switch 96 via a dedicated NIC 104. Thus, each storage unit 32 is defined as an independent network node, and communicates with switch 96, e.g., using Ethernet protocols. In this configuration, the functionality of server 112 (or unit 32) is embedded in queriable storage units 36. For example, the filtering logic in this configuration may run applicative processes such as predictive analytics or rule engines.

### Data Storage and Retrieval Methods

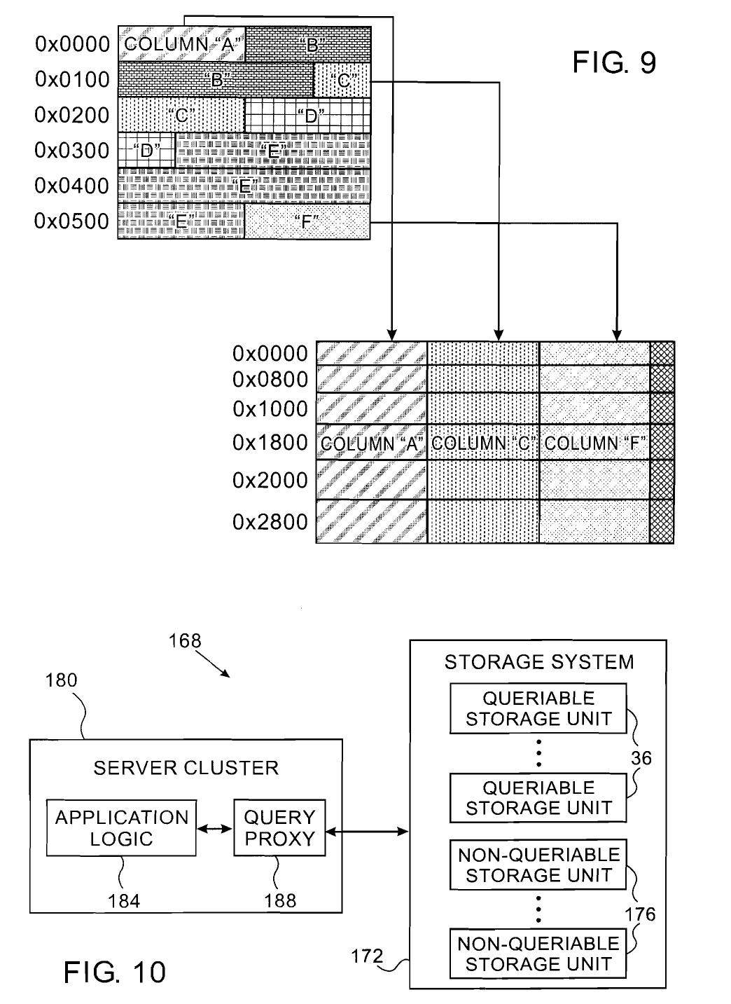

FIG. 7 is a flow chart that schematically illustrates a method for data storage, in accordance with an embodiment of the present invention. The following description makes reference to the configuration of FIG. 1 above. The disclosed method, however, can also be used with any other suitable system configuration, such as the configurations of FIGS. 5 and 6 above.

The method begins with data processing unit 32 of system 20 accepting tabular data for storage, at a data input step 120. The data may comprise, for example, one or more database tables. Unit 32 divides the input tabular data into tiles, at a tile division step 124. Unit 32 allocates the tiles at random to the different memory devices 40 in storage units 36, at a tile allocation step 128. Example tile division and allocation schemes, which can be used for this purpose, were discussed in detail in FIG. 2 above. In alternative embodiments, unit 32 may allocate tiles to storage units 36 without specifying individual memory devices 40. In these embodiments, assignment of tiles to specific devices 40 is performed internally to the storage unit. Unit 32 sends each storage unit 36 the tiles that were allocated thereto, and logic 44 in each storage unit 36 stores the data in the appropriate memory devices 40, at a storage step 132.

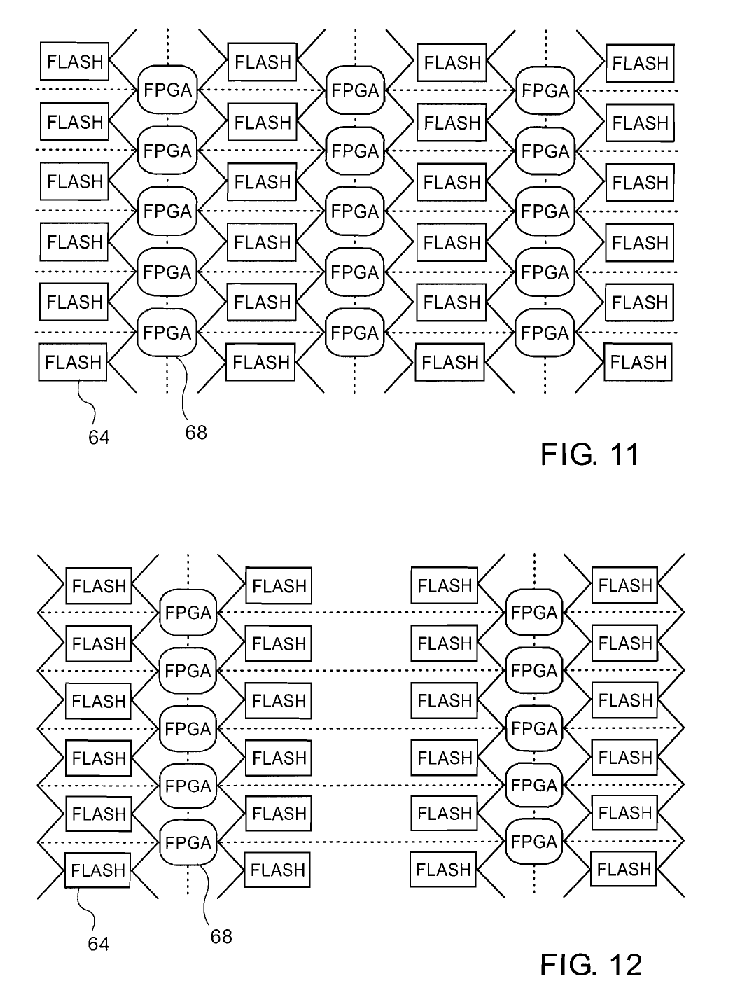

FIG. 8 is a flow chart that schematically illustrates a method for query processing, in accordance with an embodiment of the present invention. The method of FIG. 8 can be used for processing analytical queries in data that was stored using the method of FIG. 7 above. The following description makes reference to the configurations of FIGS. 1 and 3 above, however the method of FIG. 8 can also be used with any other suitable system configuration.

The method begins with data processing unit 32 of system 20 accepting from user 24 an analytical query to be applied to the data stored in units 36, at a query input step 140. The analytical query may comprise, for example, a Structured Query Language (SQL) or Multidimensional Expressions (MDX) query, or it may alternatively conform to any other suitable format or language.

Unit 32 parses and parallelizes the analytical query, at a parallelization step 144. The output of this step is a set of sub-queries, which are to be executed in concurrently by FPGAs 68 of queriable storage units 36 on different portions of the stored data. Typically although not necessarily, each sub-query is addressed to the data of a given tile 52. As such, the number of sub-queries into which a given analytical query is parsed may reach the number of tiles, i.e., thousands or even millions.

Consider, for example, an analytical query that requests retrieval of the transaction in which the unit price multiplied by the number of units sold is highest. This query can be expressed as “Select max(quantity*price) from sales”. Unit 32 may parallelize this query by restructuring it into “Select max($res0) from (select max(quantity*price) from $sales_partition0) union (select max(quantity*price) from $sales_partition1)”. The restructured query comprises three sub-queries, which can be executed in parallel, e.g., by different data processors or different FPGAs. Typically, unit 32 assigns the execution of a given sub-query to the FPGA, which is associated with the memory device holding the data accessed by that sub-query.

Unit 32 sends each sub-query to the appropriate FPGA 68 in the appropriate storage unit 36, at a sub-query sending step 148. As explained above, each FPGA is associated with one or more memory devices, and is responsible for carrying out sub-queries on the tiles that are stored in these memory devices. Upon receiving the sub-queries, each FPGA pre-filters the data in the tiles stored in its associated memory devices, according to the sub-query, at a pre-filtering step 152. Assuming the tiles were assigned to the memory devices according to the schemes of FIG. 2 above, the sub-queries are distributed approximately evenly among the FPGAs, so that the overall query processing task is parallelized efficiently.

The different storage units 36 send the filtered data, i.e., the results of the sub-queries, back to data processing unit 32. Unit 32 accumulates the filtered data from the different units 36, at a result accumulation step 156. In some embodiments, unit 32 applies additional filtering to the filtered data, so as to produce a result of the analytical query, at an additional filtering step 160. In alternative embodiments, all filtering is performed in storage units 36 and there is no need to apply additional filtering by unit 32. Unit 32 outputs the result of the analytical query to user 24 via user terminal 28, at an output step 164.

As can be appreciated from the above description, system 20 may apply two stages of filtering or query processing in response to the analytical query. Initial filtering is carried out in parallel by queriable storage units 36. The output of units 36 is further filtered by data processing unit 32. The amount of pre-filtering applied by storage units 36 can be traded with the amount of additional filtering applied by unit 32. At one extreme, all filtering related to the analytical query is performed by units 36, and unit 32 merely merges the filtered data produced by the different units 36. At the other extreme, units 36 perform only a marginal amount of filtering, allowing a relatively large volume of uncertain data to reach unit 32.

The trade-off may depend on various factors, such as the computational capabilities of units 36 in comparison with the computational capability of unit 32, constraints on communication bandwidth between units 36 and unit 32, latency constraints in units 36 or unit 32, the type of analytical query and/or the type of data being queried.

### Data Rotation During Query Processing

When storing a given tile 52 in a certain Flash device 64, the data can be stored in the Flash pages row by row (i.e., rows of the tile are laid along the Flash pages) or column by column (i.e., columns of the tile are laid along the Flash pages). Column-by-column storage lends itself to efficient compression, since the data elements along a given page are typically similar in characteristics. Query processing, on the other hand, is often more efficient to carry out on data that is laid row by row. In some embodiments, FPGA 68 stores each tile in a column-by-column orientation, and rotates the tile to a row-by-row orientation in order to process the sub-query. This technique enables both compact storage and efficient processing.

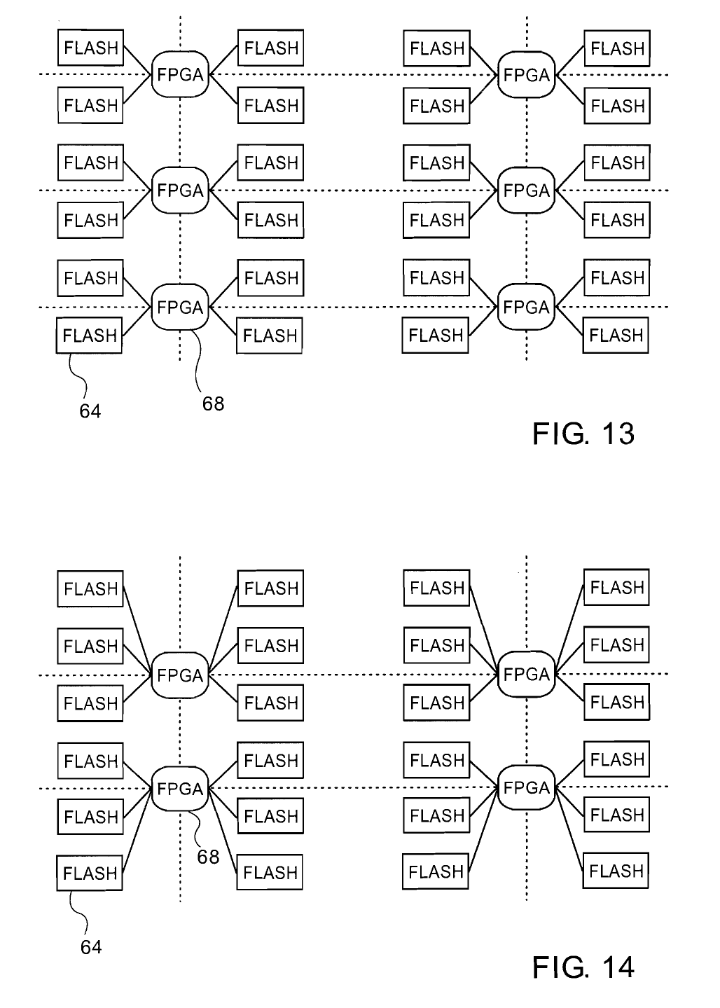

FIG. 9 is a diagram that schematically illustrates a data rotation process carried out by FPGA 68, in accordance with an embodiment of the present invention. In the example of FIG. 9, six columns of a certain tile, which are denoted A . . . F, are stored column-by-column in six pages of a certain Flash device 64. The six pages are shown in the figure as having addresses 0x0000,0x0100, . . . ,0x0500. In response to a certain sub-query that requests access to columns A, C and F, the FPGA reads the relevant columns from the Flash device, and rotates them to a row-by-row orientation. The rotated configuration is shown at the bottom of the figure. The rotated columns are stored in this manner in a RAM device that is part of the queriable storage unit, in the present example in addresses 0x0000-0x2800. The FPGA filters the data of the tile, according to the sub-query, using the rotated columns stored in RAM. Since the rotation is performed in real time in response to a specific sub-query, it is typically sufficient to rotate only the columns addressed by the sub-query, and not the entire tile.

### Cooperative Scanning Mechanism

In some embodiments, system 20 reduces the overhead associated with tile handling by identifying multiple queries that refer to the same tile. In these embodiments, unit 32 typically accumulates the incoming queries (e.g., in a buffer) for a certain period of time. During this period, unit 32 attempts to identify queries that access the same tile 52. Once identified, these queries are processed together, so that the tile in question is read from memory, parsed, rotated, decompressed, decrypted and/or buffered only once. In some embodiments, the identified queries are combined into a single complex query. Alternatively, the queries can be executed separately once the tile is ready for processing.

### Data Aggregation by Storage Units

The description above refers mainly to filtering operations performed by queriable storage units 36 in response to queries. In some embodiments, however, units 36 are capable of aggregating data and providing aggregated results in response to queries. Unlike filtering, data aggregation operations produce data that was not stored in memory α-priori, but is computed in response to a query. Data aggregation operations reduce the communication volume between units 36 and unit 32, but retain at least some of the information content of the raw data. For example, in response to a query, filtering logic 44 in unit 36 may compute and return various statistical properties of a given data column, such as mean, variance, median value, maximum, minimum, histogram values or any other suitable statistical property. As another example, unit 36 may compute the sum of a certain data column. Another type of aggregation operation is sampling, i.e., returning only a subset of a certain data column according to a predefined pattern, such as every second element or every third element. Further alternatively, units 36 may perform any other suitable type of data aggregation operation on the stored data in response to a query.

### Data Format for Storage in Queriable Storage Units

Typically, the data is stored in memory devices 40 (e.g., Flash devices 64) in a raw format that enables straightforward access and processing by the filtering logic (e.g., FPGAs 68). For example, each tile 52 is typically stored in a contiguous block of physical memory addresses, preferably with little or no data hierarchy, complex data layers or data structures, logical/physical address mapping or other complex formats. In some embodiments, unit 32 receives the data for storage in a format that comprises one or more of the above-mentioned features. In these embodiments, unit 32 typically converts the data into the raw format in which it will be stored.

In alternative embodiments, data having a complex format is translated by unit 32 into a stream of software code instructions. The data is embedded into the instruction stream as immediate arguments of code instructions. The instruction stream is stored in memory. One or more FPGAs 68 are configured to run processor cores that are capable of executing this instruction stream, once the stream is read from memory. In order to apply a certain query to this sort of data representation, the processor cores are invoked to execute the instruction stream stored in memory.

This technique enables logic 44 to process data having a complex format, which does not lend itself to straightforward processing by hardware logic. In other words, data having a complex format can be stored as executable code, whose execution by the hardware logic accesses the data.

### Compatibility with Non-Queriable Storage Units

In some embodiments, one or more queriable storage units are deployed together with one or more conventional, non-queriable storage units in the same storage system. Such a configuration is advantageous, for example, for maintaining compatibility with legacy system configurations.

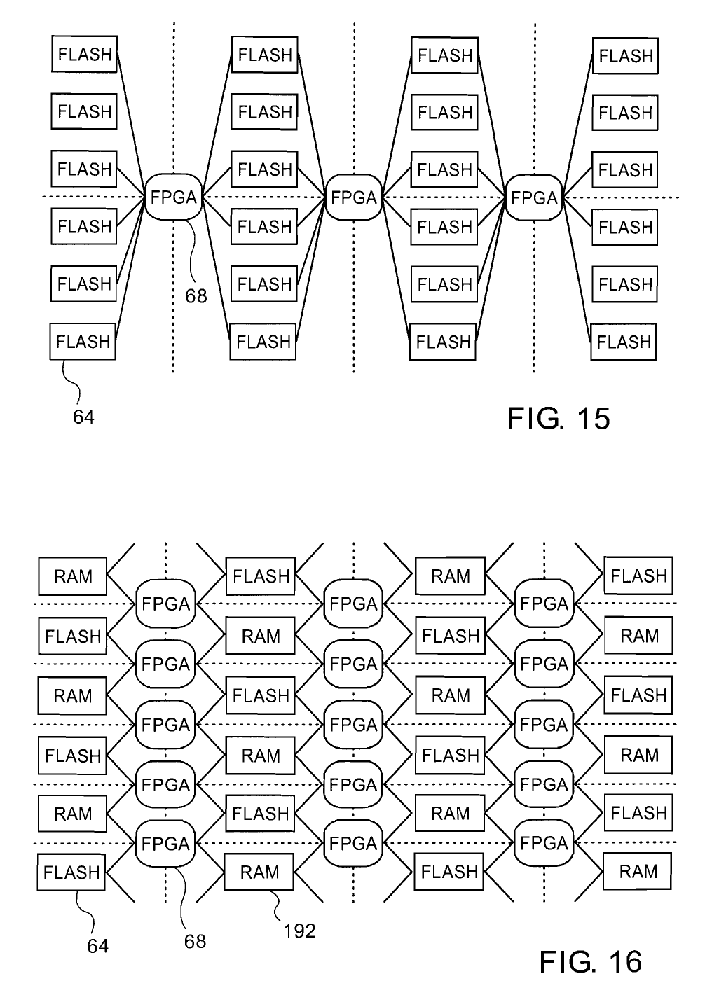

FIG. 10 is a block diagram that schematically illustrates a system 168 for data storage and retrieval, in accordance with an embodiment of the present invention. System 168 comprises a storage sub-system 172, which comprises both queriable storage units 36 and non-queriable storage units 176. The queriable storage units are similar in functionality to units 36 described in FIG. 1 above. The non-queriable storage units, on the other hand, may comprise any suitable type of storage unit known in the art. Typically, units 36 and 136 used in sub-system 172 conform to a common mechanical and electrical interface, and can be inserted interchangeably into generic slots in sub-system 172.

The data stored in sub-system 172 is accessed by a server cluster 180. The server cluster comprises applications 184, which store and retrieve data, and a query proxy 188, which interfaces with storage sub-system 172. Proxy 188 communicates with sub-system 172 using a certain storage protocol, such as, for example, Small Computer System Interface (SCSI), Internet-SCSI (iSCSI), SCSI over Infiniband, Serial-attached SCSI (SAS), Fibre-Channel (FC), Advanced Technology Attachment (ATA), Parallel ATA (PATA) or Serial ATA (SATA), or any other suitable protocol.

In some embodiments, the storage protocol used between proxy 188 and sub-system 172 is extended to support commands that enable proxy 188 to operate queriable storage units 36 using the methods described above (e.g., the methods of FIGS. 7 and 8). Proxy 188 is also designed to support the extended protocol, and to carry out the functions of data processing unit 32. The storage protocol is typically extended in a non-intrusive, backward-compatible manner that does not affect the operation of non-queriable storage units 176. Typically, the commands that are unique to queriable storage units 36 are forwarded to units 36 in a pass-through mode that is transparent to the non-queriable storage units. In some embodiments, units 36 can be operated in a backward-compatible legacy mode, in which they function similarly to non-queriable units 176 and do not carry out filtering.

### Multitenant Operation

System 20 may be operated so as to provide storage and query processing services to multiple clients, which may belong to different organizations. The users may connect to the system, for example, over the Internet or other network. Multitenant operation of this sort has several aspects, such as data security and usage metering, which are addressed by the system design.

In some embodiments, unit 32 separates (isolates) the data belonging to different user groups (e.g., organizations, also referred to as tenants) in order to prevent data leakage or exposure from group to group. Typically, the isolation enforced by unit 32 is implemented at the hardware level rather than at higher system levels. Typically, each tenant is assigned a separate memory region (e.g., separate storage units or memory devices), whose size is measured accurately. The system hardware ensures that a given tenant cannot access the memory region of another tenant. Other hardware resources, such as FPGAs, are also assigned to different tenant at the hardware level.

Typically, the system continually ensures that each tenant does not consume more than its pre-allocated storage or processing resources. Using this hardware-level multi-tenant scheme, functions such as charging and billing (pre-paid or post-paid) and capacity control can be implemented in a straightforward manner. In some embodiments, hardware resources are pre-allocated to the different tenants so as to prevent the service provider from experiencing overbooking.

In some embodiments, system 20 measures the system resources used by each tenant, for example in order to bill for the service. Metered resources may comprise, for example, memory space (data size), communication volume, query count, or any other suitable resource. In a typical application, the system meters the resources during the execution of each query. In some embodiments, the resources allocated to a certain tenant are limited to certain minimum or maximum values, e.g., according to a pre-specified Service Level Agreement (SLA).

### Alternative Interconnection Topologies for Queriable Data Storage Units

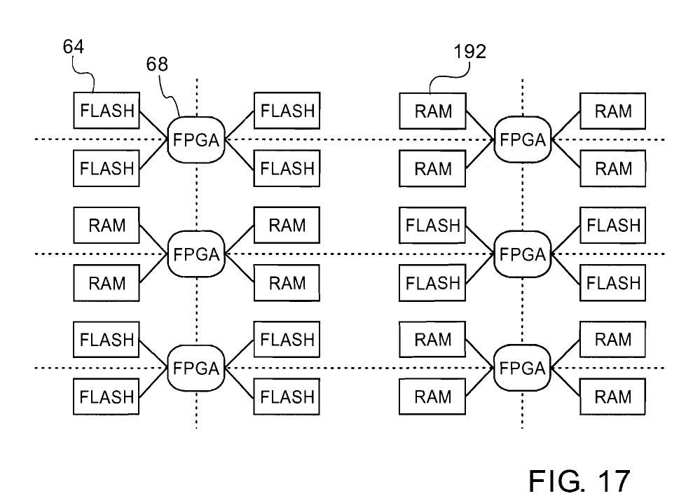

FIGS. 11-17 are block diagrams that schematically illustrate example interconnection topologies in a queriable data storage unit, in accordance with embodiments of the present invention. Each of these topologies can be used to implement data storage units 36, as an alternative to the topology of FIG. 3 above.

FIG. 11 shows a mesh interconnection scheme, in which a given Flash device 64 can be controlled by multiple FPGAs 68 and neighboring FPGAs can communicate with one another. In the interconnection scheme of FIG. 12, the Flash devices and FPGAs are divided into two groups, but FPGAs may communicate with one another both inside and outside the group. In FIG. 13, the Flash devices are arranged in four-device clusters, and each Flash device is controlled by a single FPGA. FIG. 14 has a similar structure that uses lager clusters of six Flash devices. In FIG. 15, the Flash devices are arranged in groups, and each group is controlled by two adjacent FPGAs. In FIGS. 16 and 17, some of the memory devices comprise RAM devices 192. In the interconnection scheme of FIG. 16, the RAM devices are distributed across the unit, such that each FPGA has direct access to both FLASH and RAM devices. The interconnection scheme of FIG. 17 comprises separate clusters of Flash and RAM devices, such that a given FPGA is directly connected either to Flash devices or to RAM devices.

### Additional Embodiments and Variations

In any of the interconnection schemes described herein, unit 36 may selectively deactivate parts of the memory and the filtering logic (e.g., individual memory devices and/or FPGAs) in order to reduce power consumption. For example, unit 36 may deactivate components that are identified as idle. Alternatively, unit 36 may activate parts of the memory and processing logic progressively, as additional data is accepted for storage.

In some embodiments, filtering logic 44 in queriable storage units 36 comprises an SQL query processor or rule engine. When using a rule engine, rules are provided by data processing unit 32 as part of the query, and data stored in memory devices 40 is interpreted as facts.

Although the embodiments described herein mainly address processing of analytical queries in data storage systems, the methods and systems described herein can also be used in other applications, such as keyword searching in voice conversation archives, face searching in surveillance camera video archives, DNA and protein sequence searching in bioinformatics databases, e.g., in drug discovery applications, log processing for root-cause analysis of failures in telecom systems or other electronic systems, and/or medical data archive processing (e.g., text, numeric, tomography images or ultrasound images) that search for correlations and reason-cause links for various diseases and drug effects.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A data storage apparatus, comprising:
multiple storage units, each storage unit comprising:
one or more memory devices, which are operative to store a data partition that is drawn from a data structure and assigned to the storage unit; and
logic circuitry, which is configured to accept one or more sub-queries addressed to the storage unit and to process the respective data partition stored in the storage unit responsively to the sub-queries, so as to produce filtered data; and
a data processing unit, which is configured to transform an input query defined over the data structure into the sub-queries, to provide the sub-queries to the storage units, and to process the filtered data produced by the storage units, so as to generate and output a result in response to the input query.

2. The apparatus according to claim 1, wherein the data structure comprises data elements stored in multiple rows and columns, and wherein the data processing unit is configured to divide the data structure into multiple tiles, each tile comprising the data elements that are stored in an intersection of a respective first sub-range of the rows and a respective second sub-range of the columns, and to store the data structure by distributing the tiles among the storage units.

3. The apparatus according to claim 2, wherein the data processing unit is configured to distribute the tiles among the memory devices in accordance with a random pattern.

4. The apparatus according to claim 2, wherein the data processing unit is configured to distribute a subset of the tiles that are associated with a given sub-range of the rows substantially evenly among the memory devices.

5. The apparatus according to claim 2, wherein the data processing unit is configured to distribute a first subset of the tiles that are associated with a first sub-range of the rows among the memory devices according to a first distribution, and to distribute a second subset of the tiles that are associated with a second sub-range of the rows, which succeeds the first sub-range, according to a second distribution that is different from the first distribution.

6. The apparatus according to claim 2, wherein the logic circuitry in a given storage unit is configured to store a given tile in the memory devices in a first orientation, and, in response to a given sub-query that addresses the given tile, to rotate the given tile to a second orientation and to execute the given sub-query using the rotated tile.

7. The apparatus according to claim 1, wherein the data processing unit is configured to define a given sub-query that addresses a given data partition stored in a given storage unit, and to provide the given sub-query to the given storage unit for processing.

8. The apparatus according to claim 1, wherein the logic circuitry in a given storage unit is configured to filter the data partition stored in the given storage unit responsively to one or more of the sub-queries addressed to the storage unit.

9. The apparatus according to claim 1, wherein the data processing unit is configured to apply additional filtering to the filtered data produced by the storage units.

10. The apparatus according to claim 1, wherein the logic circuitry in a given storage unit is configured to perform a data aggregation operation on the data partition stored in the given storage unit responsively to one or more of the sub-queries addressed to the storage unit.

11. The apparatus according to claim 1, wherein the logic circuitry in a given storage unit is configured to apply at least one of a logic operation and an arithmetic operation to the data partition stored in the given storage unit.

12. The apparatus according to claim 1, wherein the logic circuitry comprises programmable logic, and wherein the data processing unit is configured to reconfigure the programmable logic responsively to a criterion defined over at least one of the data structure and the input query.

13. The apparatus according to claim 1, wherein a given storage unit comprises at least one asymmetric interface for data storage and retrieval in the memory devices of the given storage unit, the asymmetric interface having a first bandwidth for the data storage and a second bandwidth, higher than the first bandwidth, for the data retrieval.

14. The apparatus according to claim 1, wherein the logic circuitry in a given storage unit is configured to compress at least some of the data partition assigned to the given storage unit prior to storing the data partition in the memory devices.

15. The apparatus according to claim 14, wherein the logic circuitry in the given storage unit is configured to apply a given sub-query to the compressed data partition so as to produce the filtered data, and to decompress only the filtered data.

16. The apparatus according to claim 1, wherein the data processing unit is configured to encrypt data exchanged with the storage units and with end users.

17. The apparatus according to claim 1, wherein the logic circuitry in a given storage unit is configured to encrypt data stored in the memory devices.

18. The apparatus according to claim 1, and comprising multiple Network Interface Cards (NICs) coupled to the respective storage units, wherein the storage units are configured to exchange data over a network via the respective NICs.

19. The apparatus according to claim 1, wherein the storage units are configured to communicate with one another so as to exchange data for processing the sub-queries.

20. The apparatus according to claim 1, wherein the data processing unit is configured to identify input queries whose processing accesses common data elements, and to cause the storage units to access the common data elements jointly while processing the identified input queries.

21. The apparatus according to claim 1, wherein the data processing unit is configured to convert the data structure into a raw data format, so as to produce data partitions having the raw data format for storage in the storage units.

22. The apparatus according to claim 1, wherein the data processing unit is configured to represent a given data partition, which is assigned to a given storage unit and has a given data format, using code that is executable by the given storage unit, and wherein the logic circuitry in the given storage unit is configured to access the given data format by executing the code.

23. The apparatus according to claim 1, wherein the logic circuitry in a given storage unit is configured to communicate using a communication protocol that is compatible with another type of storage units, which do not have query processing capabilities.

24. The apparatus according to claim 1, wherein the data processing unit is configured to allocate first and second separate sets of hardware elements in the multiple storage units to respective first and second user groups, and to prevent access of users in the first group to the hardware elements in the second set.

25. The apparatus according to claim 24, wherein the allocated hardware elements comprise at least one element type selected from a group of types consisting of ones of the storage units, ones of the memory devices and parts of the logic circuitry.

26. The apparatus according to claim 1, wherein the data processing unit is configured to measure an amount of a resource of the apparatus that is used in processing the input query.

27. The apparatus according to claim 1, wherein the logic circuitry in a given storage unit is configured to deactivate at least one hardware component of the given storage unit so as to reduce power consumption of the given storage unit.

28. The apparatus according to claim 1, wherein the logic circuitry in a given storage unit is configured to run one of a Structured Query Language (SQL) query processor and a SQL rule engine.

29. A data storage apparatus, comprising:
a storage unit, which comprises:
one or more memory devices, which are operative to store data; and
circuitry, which is configured to apply a first filtering operation to the stored data in response to a query defined over the data, so as to produce pre-filtered data; and
a data processing unit, which is configured to receive the pre-filtered data from the storage unit and to apply a second filtering operation to the pre-filtered data, so as to produce a result of the query.

30. A data storage apparatus, comprising:
a storage unit, which comprises:
one or more memory devices, which are operative to store data; and
circuitry, which is configured to apply a data aggregation operation to the stored data in response to a query defined over the data, so as to produce pre-processed data; and
a data processing unit, which is configured to receive the pre-processed data from the storage unit and to process the pre-processed data, so as to produce a result of the query.

31. The apparatus according to claim 30, wherein the data aggregation operation comprises computation of a statistical property of at least some of the stored data.

32. The apparatus according to claim 30, wherein the data aggregation operation comprises computation of a sum of at least some of the stored data.

33. The apparatus according to claim 30, wherein the data aggregation operation comprises producing a sample of at least some of the stored data.

34. A method for data storage, comprising:
storing a plurality of data partitions drawn from a data structure in a respective plurality of storage units;
transforming an input query defined over the data structure into multiple sub-queries and providing the sub-queries to the storage units;
using logic circuitry in each storage unit, accepting one or more of the sub-queries addressed to the storage unit, and processing a respective data partition stored in the storage unit responsively to the accepted sub-queries, so as to produce filtered data; and
processing the filtered data produced by the multiple storage units, so as to generate and output a result in response to the input query.

35. The method according to claim 34, wherein the data structure comprises data elements stored in multiple rows and columns, and wherein storing the data partitions comprises dividing the data structure into multiple tiles, each tile comprising the data elements that are stored in an intersection of a respective first sub-range of the rows and a respective second sub-range of the columns, and distributing the tiles among the storage units.

36. The method according to claim 35, wherein distributing the tiles comprises distributing the tiles among the memory devices in accordance with a random pattern.

37. The method according to claim 35, wherein distributing the tiles comprises distributing a subset of the tiles that are associated with a given sub-range of the rows substantially evenly among the memory devices.

38. The method according to claim 35, wherein distributing the tiles comprises distributing a first subset of the tiles that are associated with a first sub-range of the rows among the memory devices according to a first distribution, and distributing a second subset of the tiles that are associated with a second sub-range of the rows, which succeeds the first sub-range, according to a second distribution that is different from the first distribution.

39. The method according to claim 35, wherein processing the data partition comprises storing a given tile in a first orientation, and, in response to a given sub-query that addresses the given tile, rotating the given tile to a second orientation executing the given sub-query using the rotated tile.

40. The method according to claim 34, wherein transforming the input query comprises defining a given sub-query that addresses a given data partition stored in a given storage unit, and wherein providing the sub-queries comprises providing the given sub-query to the given storage unit for processing.

41. The method according to claim 34, wherein processing the data partition comprises filtering the data partition responsively to one or more of the sub-queries addressed to the storage unit.

42. The method according to claim 34, wherein processing the filtered data comprises applying additional filtering to the filtered data produced by the storage units.

43. The method according to claim 34, wherein processing the data partition comprises performing a data aggregation operation on the data partition responsively to one or more of the sub-queries addressed to the storage unit.

44. The method according to claim 34, wherein processing the data partition comprises applying at least one of a logic operation and an arithmetic operation to the data partition.

45. The method according to claim 34, wherein the logic circuitry includes programmable logic, and comprising reconfiguring the programmable logic responsively to a criterion defined over at least one of the data structure and the input query.

46. The method according to claim 34, wherein processing the data partition comprises performing data storage and retrieval using at least one asymmetric interface, the asymmetric interface having a first bandwidth for the data storage and a second bandwidth, higher than the first bandwidth, for the data retrieval.

47. The method according to claim 34, wherein storing the data partitions comprises compressing at least some of a data partition assigned to a given storage unit prior to storing the data partition.

48. The method according to claim 47, wherein processing the data partition comprises applying a given sub-query to the compressed data partition so as to produce the filtered data, and decompressing only the filtered data.

49. The method according to claim 34, and comprising encrypting data exchanged with the storage units and with end users.

50. The method according to claim 34, wherein storing the data partitions comprises encrypting the data partitions stored in the storage units.

51. The method according to claim 34, and comprising exchanging data over a network with the storage units via respective Network Interface Cards (NICs) coupled to the storage units.

52. The method according to claim 34, wherein processing a given data partition by a given storage unit comprises communicating with another storage unit so as to exchange data for processing the sub-queries.

53. The method according to claim 34, and comprising identifying input queries whose processing accesses common data elements, and causing the storage units to access the common data elements jointly while processing the identified input queries.

54. The method according to claim 34, wherein storing the data partitions comprises converting the data structure into a raw data format, and storing the data partitions having the raw data format in the storage units.

55. The method according to claim 34, wherein storing the data partitions comprises representing a given data partition, which is assigned to a given storage unit and has a given data format, using code that is executable by the given storage unit, and wherein processing the given data partition comprises executing the code by the given storage unit so as to access the given data format.

56. The method according to claim 34, and comprising communicating with the storage units using a communication protocol that is compatible with another type of storage units, which do not have query processing capabilities.

57. The method according to claim 34, and comprising allocating first and second separate sets of hardware elements in the plurality of the storage units to respective first and second user groups, and preventing access of users in the first group to the hardware elements in the second set.

58. The apparatus according to claim 57, wherein the allocated hardware elements comprise at least one element type selected from a group of types consisting of ones of the storage units, ones of the memory devices and parts of the logic circuitry.

59. The method according to claim 34, and comprising measuring an amount of a resource that is used in processing the input query.

60. The method according to claim 34, and comprising deactivating at least one hardware component of a given storage unit so as to reduce power consumption of the given storage unit.

61. The method according to claim 34, wherein processing the data partition comprises running one of a Structured Query Language (SQL) query processor and a SQL rule engine.

62. A method for data storage, comprising:
storing data in a storage unit that includes processing circuitry;
using the processing circuitry in the storage unit, applying a first filtering operation to the stored data in response to a query defined over the data, so as to produce pre-filtered data; and
applying a second filtering operation to the pre-filtered data by a processor separate from the storage unit, so as to produce a result of the query.

63. A method for data storage, comprising:
storing data in a storage unit that includes processing circuitry;
using the processing circuitry in the storage unit, applying a data aggregation operation to the stored data in response to a query defined over the data, so as to produce pre-processed data; and
processing the pre-processed data by a processor separate from the storage unit, so as to produce a result of the query.

64. The method according to claim 63, wherein the data aggregation operation comprises computation of a statistical property of at least some of the stored data.

65. The method according to claim 63, wherein the data aggregation operation comprises computation of a sum of at least some of the stored data.

66. The method according to claim 63, wherein the data aggregation operation comprises producing a sample of at least some of the stored data.
